(19) United States
(12) Patent Application Publication
(10) Pub. No.: US 2016/0187574 A1
(43) Pub. Date: Jun. 30, 2016

(54) LIGHT-EMITTING DEVICE AND A WEARABLE STRUCTURE WITH LIGHT FUNCTION

(71) Applicant: SHEN-KO TSENG, Taipei City (TW)

(72) Inventor: SHEN-KO TSENG, Taipei City (TW)

(21) Appl. No.: 14/983,362

(22) Filed: Dec. 29, 2015

(30) Foreign Application Priority Data
Dec. 31, 2014 (CN) 201420867672.8

(51) Int. Cl. F21V 8/00; F21V 33/00; F21V 23/06; F21V 23/02; F21V 23/04

(52) U.S. Cl. CPC G02B 6/0088; F21V 23/02; F21V 23/04; F21V 23/0407; F21V 23/06; F21V 33/0008; F21W 2121/06

(57) ABSTRACT

The present invention provides a light-emitting device comprising a light-emitting element, light guiding element, a loading structure and a transparent media. The light-emitting element is used to emit the light. The light guiding plate has an input plane and an output plane, and the input plane is coupled to the light-emitting element for guiding the light from the output plane. The transparent media with a pattern is coupled to the loading structure for covering the output plane of the light guiding plate. The light guided by the light guiding plate penetrates the pattern of the transparent media. The present invention also relates to a wearable structure having the light function. The wearable structure comprises a main body and a light-emitting device set on the main body. The light-emitting device comprises a light-emitting element, a light guiding plate and a transparent media for making the wearable structure to create different visual effects of the light.

### BACKGROUND OF THE INVENTION

1. Field of the invention

The present invention relates to a light-emitting device and a wearable structure for applying the light-emitting device; and more particularly, the present invention relates to light-emitting device with different visual effects and a wearable structure with light function.

2. Description of the prior art

Due to the popularity of the small light sources such as light emitting diodes in recent years, people set the light-emitting element on the non-electronic products such as shoes, clothes, hats, backpacks or anything portable/wearable objects. The form of the small light source applied to the portable belongings not only has the role of security alerts, but also has a visual effect. For example, the shoes and clothes of the pedestrians or children can emit different colors of light or glare for reminding drivers of the presence of the children or the pedestrians at night or in the dim light to avoid accidents. In addition, the small light source device is usually able to create visual effects.

Currently, the small light source, the LED and the wearable structure are usually having the LED, the light-emitting element of the light emitting device disposed in the wearable structure, wherein the control circuit is disposed in the wearable structure, and the control circuit controls the light-emitting element to be set on the surface of the wearable structure, or set in the wearable structure and connected inside the light guiding element. The light emitting surface of the light-emitting element is able to emit the light toward the outside of the wearable structure. The light is able to penetrate the transparent surface of the wearable structure; a light emitted by the light-emitting element is guided to the outside of the wearable structure.

The light-emitting element is able to be used for a warning or prettifying purposes. If the light emitting from the wearable structure has different visual effects, the prettifying purpose is more significant. In the prior art, one of the methods for making the wearable structure to create different visual effects is through the installation of LEDs or the small light source emitting different colors of light. In addition, the light-emitting elements are able to be lighted in the specific sequence and time span according to the built-in program set by the control circuit. Otherwise, LEDs and the small light source are also able to make a light pattern by emitting the light and letting the light guiding elements receive the light.

When the user dislikes the visual effect created by the wearable structure, the user can purchase a new same type wearable structure with different visual effects. However, if the original object is undamaged, the purchasing desire of the user is reduced.

To reduce a user's overload cost, it is essential to invent a light-emitting device or a wearable structure which is able to make different visual effects according to the preference of the user.

### SUMMARY OF THE INVENTION

The present invention provides a simple light-emitting device and a wearable structure.

The present invention provides a light-emitting device, and comprises a light-emitting element, a light guiding plate a loading structure and a transparent media. The light-emitting element is for emitting light. The light guiding plate has an input plane and an output plane; the input plane is coupled to the light-emitting element and the light guiding plate guiding the light from the input plane to the output plane. The transparent media with a pattern is coupled to the loading structure for covering the output plane of the light guiding plate, wherein the transparent media is removable.

Wherein, the light-emitting element comprises a light-emitting unit and a control module for controlling the light-emitting unit to emit a flashing pattern, and the control module has a switch for turning the control module on or off.

Wherein, the light-emitting device further comprises a power source for supplying the power to the light-emitting device.

Wherein, the control module further comprises a first connecting terminal for charging the power source.

Wherein, the control module further comprises a second for receiving a light-emitting control program, wherein the control module emits the flashing pattern based on the light-emitting control program.

Wherein, the loading structure comprises a sliding slot, a Velcro or a pivoting structure.

Wherein, the light-emitting element comprises a lighting-emitting unit and a control module for controlling the light-emitting unit to emit a flashing pattern, and the control module has a switch for changing the flashing pattern.

A wearable structure has the lighting function and comprises a main body, a light-emitting device. The light-emitting device is disposed on the main body and comprises a light-emitting element, a light guiding plate, a loading structure and a transparent media. The light-emitting element is for emitting light. The light guiding plate has an input plane and an output plane, and the input plane is coupled to the light-emitting element and the light guiding plate guiding the light from the input plane to the output plane. The transparent media with a pattern is coupled to the loading structure and covers the output plane of the light guiding plate.

Wherein, the light-emitting element comprises a lighting-emitting unit and a control module for controlling the light-emitting unit to show a flashing pattern, and the control module has a switch for controlling an on-off of the control module.

Wherein, the light-emitting device further comprises a power source for supplying the power to the light-emitting device.

Wherein, the control module further comprises a first connecting terminal for charging the power source.

Wherein, the control module further comprises a second connecting terminal for receiving a light-emitting control program, wherein the control module emits the flashing pattern based on the light-emitting control program.

Wherein, the loading structure comprises a sliding slot, a Velcro or a pivoting structure.

Wherein, the light-emitting element comprises a lighting-emitting unit and a control module for controlling the light-emitting unit to emit a flashing pattern, and the control module has a switch for changing the flashing pattern.

According the structure mentioned above, the present invention creates a visual effect after the light emitted from the light guiding plate to penetrate through the transparent media; the user can observe that the light from the light-emitting device has the visual effect, and the visual effect is different when the pattern is different.

The advantages and spirits of the invention may be understood by the following recitations together with the appended drawings.

### BRIEF DESCRIPTION OF THE APPENDED DRAWINGS

Some of the embodiments will be described in detail, with reference to the following figures, wherein like designations denote like members, wherein:

FIG. 1A shows a diagram of the light-emitting device of the present invention in an embodiment.

FIG. 1B shows a sectional view of the light-emitting device along a section line A-A of the FIG. 1A.

FIG. 2 shows a diagram of the light-emitting device of the present invention in an embodiment.

FIG. 3 shows a diagram of the light-emitting device of the present invention in an embodiment.

FIG. 4 shows a diagram of the wearable structure having the lighting function of the present invention in an embodiment.

### DETAILED DESCRIPTION OF THE INVENTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

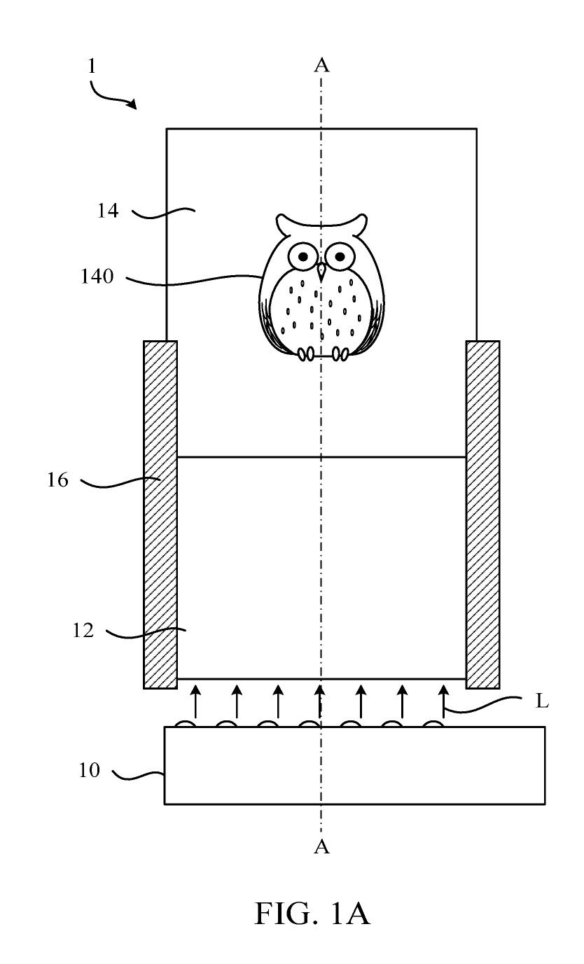

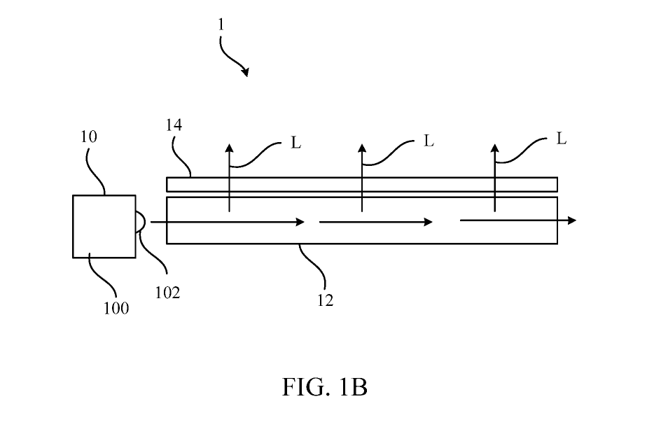

Please refer to FIG. 1A and FIG. 1B. FIG. 1A shows a diagram of the light-emitting device of the present invention in an embodiment. FIG. 1B shows a sectional view of the light-emitting device along a section line A-A of the FIG. 1A. The light-emitting device 1 comprises a light-emitting element 10, a light guiding plate 12 and a transparent media 14, wherein the light-emitting element 10 emits a light L, and the light guiding plate 12 receives the light L by the input plane and guides the light L to transmit the light L in the light guiding plate 12 and to emit the light L by the output plane. The transparent media 14 with a pattern 140 covers on the light guiding plate 12. The light L derived from the light guiding plate 12 penetrates and covers the transparent media 14 with a pattern 140 of the light guiding plate 12. The user is able to observe that the light L penetrating through the transparent media14 and the pattern 140 has the visual effect. The thickness of the light guiding plate is decreased gradually; for example, the light gets in from the thickest part of the light guiding plate and runs toward the thinnest part of the light guiding plate. The gradual decrease of the thickness of the light guiding plate helps the light go out from the presumptive output plane.

In an embodiment, the output plane of the light guiding plate 12 is the one of the surfaces having the biggest area, and the input plane is disposed around the lateral surface of the two biggest surfaces. But the light-emitting element is also able to emit the light to the one of the biggest surfaces of the light guiding plate; that is to say, the two biggest surfaces of the light guiding plate are the input plane and the output plane, respectively. However, the input plane and the output plane are not limited to be the specific surface of the light guiding plate mentioned above; any surface capable of receiving light and let the light distribute evenly on the light guiding plate is acceptable in the present invention.

In an embodiment, the light-emitting element 10 comprises a control module 100 and at least one light-emitting unit 102; the light-emitting unit 102 is controlled to light by the control module 100. The control module 100 comprises a control circuit and a switch, and the light-emitting unit 102 is coupled to the control circuit. The switch turns the control module on or off, and the light-emitting unit 102 is able to light according to different modality and different time spans by the on-off of the control module 100 controlled by the switch. For example, the light-emitting unit 102 can shine once, light continually, shine continually, shine with a specific sequence time span like 0.5 s, 0.5 s and 1 s, or shine in combination with the methods mentioned above. That is to say, the switch changes the flashing pattern.

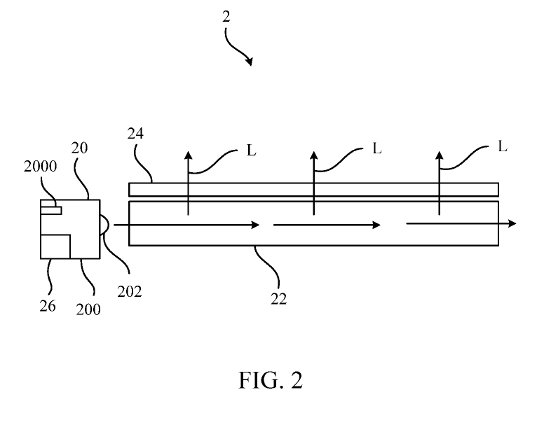

Please refer to FIG. 2. FIG. 2 shows a diagram of the light-emitting device of the present invention in an embodiment. In an embodiment, the light-emitting device 2 not only comprises a light-emitting element 20, a light guiding plate 22 and a transparent media 24 but also comprises a power source 26; the power source 26 is connected to the control module 200 and supplies the power to the control module 200 and the light-emitting unit 202. The light-emitting element 20, the light guiding plate 22 and the transparent media 24 in the embodiment are almost the same with the light-emitting element 10, the light guiding plate 12 and the transparent media 14. Besides, the control module 200 further comprises a connecting terminal 2000 connecting to the external electrical device for charging the power source and receiving the information. For example, in an embodiment, the connecting terminal 2000 connects to the external power source and receives the power from the external power source for charging the power source 26. In an embodiment, the control module 200 has a programmable IC chip, and the programmable IC chip is able to transmit a light-emitting control program to the external electrical device like the external computer system or the information storage system through the connecting terminal 2000 and control the lighting modality of the light-emitting unit 202 according the light-emitting control program.

Please refer to FIG. 1A. The transparent media 14 has a transparent or semitransparent pattern 140. The transmittance of the transparent media 14 is, but not limited to, the pattern 140. The light L has a visual effect by penetrating the pattern 140 and the transparent media 14; for example, in an embodiment, the user can observe a shining owl by watching the transparent media 14. If the pattern 140 of the transparent media14 is the other animal, the user is able to observe the other shining animal. Namely, the pattern 140 of the transparent media 14 in the embodiment can be, but not limited, an owl or other animals in the real application; the pattern 140 is able to be the plant, the human-made object, the natural object, the scenery, the image, etc. The pattern 140 is also able to be the combination of the lines, the colors and the things mentioned above.

Because the light L has visual effect by penetrating the pattern 140 and the transparent media 14, the visual effect is different when the pattern 140 of the transparent media 14 is different. In FIG. 1A, the light-emitting device 1 further comprises a loading structure 16, and the transparent media 14 is able to be connected to the loading structure 16. The loading structure 16 helps the transparent media 14 cover the light guiding plate 12, and transparent media 14 is moved by the loading structure 16. In the embodiment, the loading structure 16 has two elements set on the two sides of the light guiding plate 12, the two elements have the corresponding sliding slot, and the transparent media 14 is able to get into the two sliding slots from the lateral surface and cover the light guiding plate 12 (at the location of the transparent media 14 showed in the FIG. 1B) by moving toward along the sliding slots. If the user wants to change the different transparent media 14, the original transparent media 14 is needed to remove along the opposite direction of the sliding slots and the other transparent media 14 is needed to be restored. The type of the sliding slot of the loading structure 16 in the embodiment is just one of the practical plans, the loading structure is not limited to it in real application. Any type of the loading structure which is able to help the transparent media 14 to cover the light guiding plate 12 and withdraw from the light guiding plate 12 is able to be used in real application. For example, the loading structure is able to be the Velcro for fixing the transparent media 14, the loading structure is also able to be the pivoting structure disposed on the one side of the light guiding plate; the holding structure is able to rotate to hold or release a transparent media 14 in a vertical angle and hold the transparent media to rotate to a standard angle to make the transparent media 14 cover the light guiding plate 12.

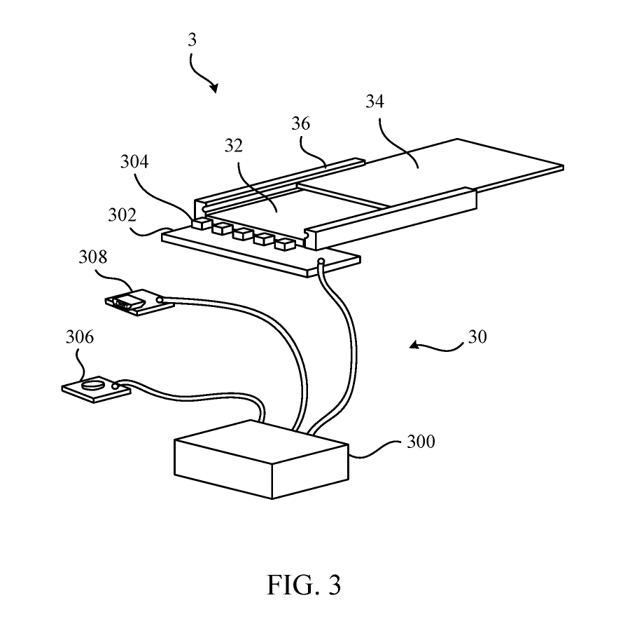

Please refer to FIG. 3. FIG. 3 shows a diagram of the light-emitting device of the present invention in an embodiment. The light-emitting device 3 comprises a light-emitting element 30, a light guiding plate 32, a transparent media 34 and a loading structure 36. Comparing with the embodiment, the elements of the light-emitting element 30 is not integrated to one but separable, and every elements of the light-emitting element 30 are connected with each other by the wire. In an embodiment, the light-emitting element 30 comprises a control module 300, a loading substrate 302 and a plurality of the light-emitting units 304 set on the loading substrate 302. Besides, the control module 300 further comprises a switch 306 and connecting terminal 308, and the elements of the light-emitting element 30 are connected to other elements by wire. When the light-emitting device is set on a wearable structure, the elements is able to be set on the different parts of the wearable structure separately and be hidden to maintain the neat surface of the wearable structure because the elements of the light-emitting element 30 are connected to other elements by wire. Although the elements of the light-emitting element 30 are connected to each other by wire in the embodiment, the designer is able to connect the elements by the wireless transmission; for example, if the control module 300 and the loading substrate 302 have the wireless access point and the wireless transmitter, the control module 300 will transmit the wireless signal by utilizing the wireless transmitter to the wireless access point of the loading substrate 302, and the loading substrate 302 will drive the light-emitting unit 304 to light according to the wireless signal.

In an embodiment, the light-emitting unit 304 is able to be a LED set on the main function surface of the loading substrate 302, and the light emitting surface of the LED is disposed on the lateral surface of the LED to light toward the lateral side. The location of the light emitting surface of the LED is different from the location of the light-emitting unit 102 disposed on the control module 100 which is showed in FIG. 1A and FIG. 1B. The light guiding plate 32 is able to be disposed on the loading substrate 302 to make the lateral surface of the light guiding plate 32 close to the light emitting surface of the light-emitting unit 304 to receive the light. The relative location of the light-emitting unit and the light guiding plate is adjustable but not limited to the location mentioned in the embodiments. For example, in an embodiment, the light emitting surface of the light-emitting unit is close to a light pipe, and the light-emitting unit transmits the light to the light guiding plate through the light pipe.

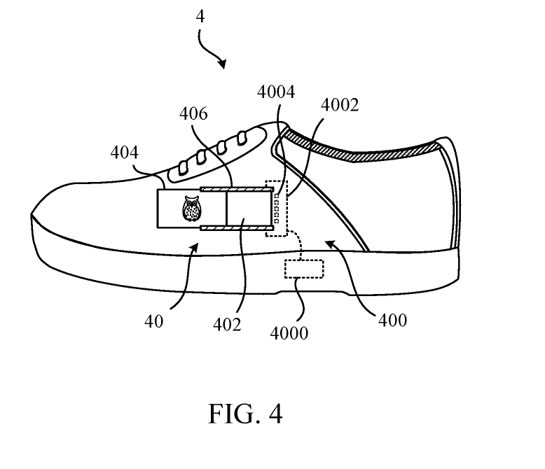

Pleases refer to FIG. 4. FIG. 4 shows a diagram of the wearable structure having the lighting function of the present invention in an embodiment. The wearable structure 4 is a shoe for people to walk, run and jump. The wearable structure 4 comprises a main body, the main body is a shoe in an embodiment, and a light-emitting device 40 is set on the shoe. The light-emitting device 40 comprises a light-emitting element 400, a light guiding plate 402, a transparent media 404 and a loading structure 406, wherein the light-emitting element 400 further comprises a control module 4000, a loading substrate 4002 and a light-emitting unit 4004. The switch of the light-emitting element 400 is able to be set in the control module 4000. The switch is triggered by the force generated by treading the shoe. The light-emitting element is able to be designed as shown in FIG. 1A, FIG. 1B, FIG. 2 and FIG. 3. That is to say, the light-emitting element is able to comprise the control module, the light-emitting unit, the power source, the connecting terminal and a switch which are able to be connected to each other under separable types and non-separable types. The designs of the light-emitting device mentioned above are able to be suitable for the light-emitting device 40 in the embodiment.

In an embodiment, the loading structure 406 is able to be disposed on the light-emitting device 40; however, in another embodiment, the loading structure is able to be disposed on the shoe, and the force is supplied by the shoe to the transparent media. Because the transparent media 404 is able to be set and covered on the shoe by the loading structure 406, and the transparent media 404 is also able to be removed easily by the loading structure 406, the user is able to change the transparent media with different patterns to get the visual effect without changing the wearable structure. The detail of the light-emitting device 40 in the embodiment is mentioned in other embodiments.

The wearable structure 4 showed in FIG. 4 is the shoe for people to wear. However, the wearable structure 4 is not limited to a shoe; it can be a cloth, a bag, a glove, a hat and any kinds of personal objects.

To sum up, the light-emitting device is able to be set on the different wearable structures to get the different visual effects by utilizing the different transparent media without changing the new wearable structures. Thus, the wearable structure is easy to become beautiful, and the cost is reduced because the visual effect is made by changing the transparent media without changing a new object.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A light-emitting device, comprising:
a light-emitting element for emitting light;
a light guiding plate having an input plane and an output plane, the input plane coupled to the light-emitting element and the light guiding plate guiding the light from the input plane to the output plane;
a loading structure; and
a transparent media with a pattern, the transparent media coupled to the loading structure for covering the output plane of the light guiding plate, wherein the transparent media is removable.

2. The light-emitting device of claim 1, wherein the light-emitting element comprises a lighting-emitting unit and a control module for controlling the light-emitting unit to emit a flashing pattern, and the control module has a switch for turning the control module on or off.

3. The light-emitting device of claim 2, wherein the light-emitting device further comprises a power source for supplying the power to the light-emitting device.

4. The light-emitting device of claim 3, wherein the control module further comprises a first connecting terminal for charging the power source.

5. The light-emitting device of claim 2, wherein the control module further comprises a second connecting terminal for receiving a light-emitting control program, wherein the control module emits the flashing pattern based on the light-emitting control program.

6. The light-emitting device of claim 1, wherein the loading structure comprises a sliding slot, a Velcro or a pivoting structure.

7. The light-emitting device of claim 1, wherein the light-emitting element comprises a lighting-emitting unit and a control module for controlling the light-emitting unit to emit a flashing pattern, and the control module has a switch for changing the flashing pattern.

8. A wearable structure having the lighting function, comprising:
a main body; and
a light-emitting device, disposed on the main body and comprising:
a light-emitting element for emitting light;
a light guiding plate having an input plane and an output plane, the input plane coupled to the light-emitting element and the light guiding plate guiding the light from the input plane to the output plane;
a loading structure; and
a transparent media with a pattern, coupled to the loading structure and covering the output plane of the light guiding plate.

9. The wearable structure of claim 9, wherein the light-emitting element comprises a lighting-emitting unit and a control module for controlling the light-emitting unit to emit a flashing pattern, and the control module has a switch for turning the control module on or off.

10. The wearable structure of claim 9, wherein the light-emitting device further comprises a power source for supplying the power to the light-emitting device.

11. The wearable structure of claim 10, wherein the control module further comprises a first connecting terminal for charging the power source.

12. The wearable structure of claim 9, wherein the control module further comprises a second connecting terminal for receiving a light-emitting control program, wherein the control module emits the flashing pattern based on the light-emitting control program.

13. The wearable structure of claim 8, wherein the loading structure comprises a sliding slot, a Velcro or a pivoting structure.

14. The wearable structure of claim 8, wherein the light-emitting element comprises a lighting-emitting unit and a control module for controlling the light-emitting unit to show a flashing pattern, and the control module has a switch for changing the flashing pattern.

15. The wearable structure of claim 8, wherein the direction of the output plane of the light guiding plate is different from the direction of the input plane of the light guiding plate.
